(19) United States
(12) Patent Application Publication
(10) Pub. No.: US 2025/0249961 A1
(43) Pub. Date: Aug. 7, 2025

(54) ARRANGEMENT OF A REMOVABLE HOOD COVERING AN ENGINE COMPARTMENT

(71) Applicant: FLEXIS, BOULOGNE-BILLANCOURT (FR)

(72) Inventor: Roberto GUERCIO, GUYANCOURT (FR)

(21) Appl. No.: 19/046,413

(22) Filed: Feb. 5, 2025

(30) Foreign Application Priority Data
Feb. 6, 2024 (FR) 2401145

(51) Int. Cl. B62D 25/12; B60Q 1/04

(52) U.S. Cl. CPC B62D 25/12; B60Q 1/04

(57) ABSTRACT

An arrangement of a removable hood covering an engine compartment. An arrangement for a motor vehicle, including: an engine compartment, a left lighting device, a right-lighting device, a hood covering the engine compartment, the hood is configured to be removable so as to provide access to the engine compartment, the hood extends between the left lighting device and the right lighting device, the hood comprises a left side extending opposite the left lighting device and a right side extending opposite the right-lighting device.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### FIELD

The present disclosure relates to an arrangement for a motor vehicle comprising an engine compartment, a left lighting device, a right lighting device, and a removable hood covering the engine compartment. The present disclosure further relates to a motor vehicle comprising such an arrangement, in particular on a front face of a motor vehicle comprising such an arrangement.

### BACKGROUND

Motor vehicles are generally provided with an engine compartment accommodating a power train of the vehicle. The engine compartment is a technical volume of the vehicle wherein are also located various functional components of the vehicle such as e.g. a battery and/or tanks for fluids. The engine compartment has to stay easily accessible so as to allow any person to carry out conventional maintenance operations such as recharging or replacing the battery and/or filling up the liquids in the different tanks.

In order to give access to the engine compartment, motor vehicles are generally equipped with a hood which can rotate about a transverse axis of the vehicle between an open position and a closed position. The transverse axis is generally positioned below the windscreen. The rotation of the hood about the transverse axis is sometimes insufficient and the user does not have clear access to the engine compartment.

Furthermore, the hood is generally articulated in rotation by means of hinges arranged at the two lateral ends of the hood. Hinges are heavy, complex, fragile and bulky devices. In particular, hinges hinder the integration of other components into the engine compartment. More particularly, the integration of hinges is generally incompatible with a design of the motor vehicle wherein lighting devices are positioned relatively high on the front face, at the lateral ends of the hood. In addition, the hinges may form obstacles that hinder the movements of a user involved in a maintenance operation in the engine compartment.

Finally, the hoods known from the prior art are generally held in the open position by means of balancers which are also bulky, heavy devices, and potentially impeding an intervention in the engine compartment.

The access to the engine compartment of such motor vehicles for maintenance operations is thereby not easy.

### SUMMARY

The goal of the present disclosure is to provide an arrangement for a motor vehicle which remedies the above drawbacks and improves the arrangements for motor vehicles known from the prior art.

More precisely, a first subject matter of the present disclosure is an arrangement for a motor vehicle which is particularly compact, reliable and simple to produce.

The present disclosure relates to an arrangement for a motor vehicle, the arrangement comprising:
an engine compartment,
a left lighting device,
a right lighting device
a hood covering the engine compartment,

the hood being removable so as to provide access to the engine compartment, the hood extending between the left lighting device and the right lighting device, the hood comprising a left side extending opposite the left lighting device and a right side extending opposite the right lighting device comprising at least one left slide and at least one right slide respectively, the left and the right side of the hood comprising at least one left slider and at least one right slider, respectively, the at least one left slider cooperating with are least one left slide and at least one right slider cooperating with at least one right slide in order to guide a movement of the hood parallel with the longitudinal axis of the vehicle and to support the hood.

The at least one left slide may comprise a substantially horizontal bottom wall, a substantially horizontal top wall, and a substantially vertical bottom wall connecting the bottom wall to the second top wall, the bottom wall forming a stop cooperating with the at least one left slider to define the position of the hood along the longitudinal axis when the hood is in the closed position.

The at least one right slide may comprise a substantially horizontal bottom wall, a substantially horizontal top wall, and a substantially vertical bottom wall connecting the bottom wall to the second top wall, the bottom wall forming a stop cooperating with the at least one right slider to define the position of the hood along the longitudinal axis when the hood is in the closed position.

The at least one left slider may comprise an elastic element that can be snap-fitted into the at least one left slide. The at least one right slider may comprise an elastic element that can be snap-fitted into the at least one right slide. The at least one left slide may comprise a first left slide and a second left slide. The at least one right slide may comprise a first right slide and a second right slide. The at least one left slider may comprise a first left slider cooperating with the first left slide and a second left slider cooperating with the second left slide. The at least one right slider may comprise a first right slider cooperating with the first right slide and a second right slider cooperating with the second right slide. The first left slide can be offset along the longitudinal axis and along the vertical axis with respect to the second left slide. The first right slide may be offset along the longitudinal axis and along the vertical axis with respect to the second right slide.

The arrangement may further comprise a windscreen, a cowl grille extending below the windscreen to receive rain water that has fallen against the windscreen, the cowl grille comprising an edge equipped with a seal, said hood further comprising a sealing surface bearing against the seal.

The hood may further comprise at least one air inlet for capturing air outside the vehicle and an air outlet intended to be connected to a conduit of a ventilation device.

The arrangement may comprise a structural element, in particular a cross-member, the hood further comprising fastening interfaces by means of which the hood is fastened, in particular screwed, to the structural element.

The arrangement may include a structural member, such as a cross-member, the structural member comprising a left support and a right support, the at least one left slide bearing on the left support, the at least one right slide bearing on the right support.

The hood may further comprise a central lighting device provided with a light source.

The present disclosure further relates to a motor vehicle comprising an arrangement as defined hereinabove, in particular the motor vehicle comprising a front face provided with an arrangement as defined hereinabove.

### BRIEF DESCRIPTION OF THE DRAWINGS

The subject matters, features and advantages of the present disclosure will be described in detail in the following description of specific embodiments given by way of illustration and not limiting with reference to the accompanying drawings, wherein:

FIG. 1 is a schematic plan view of a motor vehicle according to one embodiment of the present disclosure.

FIG. 2 is a schematic side view of a hood and of a lighting device of the motor vehicle.

FIG. 3 shows a perspective view of two slides of a lighting device of the vehicle.

FIG. 4 is a perspective view of the motor vehicle, a hood and a wheel trim being removed to access an engine compartment.

FIG. 5 is a perspective rear view of the hood of the vehicle.

FIG. 6 is a schematic side view of a slide and of a slider cooperating with the slide, according to one embodiment of the present disclosure.

FIG. 7 is a schematic side view of a front face of the vehicle.

FIG. 8 is a front perspective view of a body of the hood shown in FIG. 5.

FIG. 9 is a front perspective view of a cover of the hood shown in FIG. 5.

FIG. 10 is a front perspective view of a central lighting device of the hood shown in FIG. 5.

### DETAILED DESCRIPTION

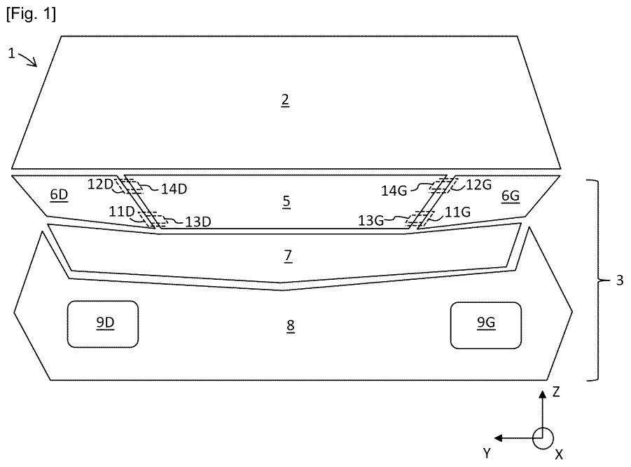

FIG. 1 schematically illustrates a motor vehicle according to an embodiment of the present disclosure. The vehicle 1 may in particular be a private vehicle, a utility vehicle, a truck or even a bus.

In the present document, the axis X refers to the longitudinal axis of the vehicle 1. In forward travel and in a straight line, the vehicle 1 moves from rear to front, along a direction parallel to the longitudinal axis thereof. The axis X is oriented from the front to the rear of the vehicle, i.e. in the direction of reversing. The axis Y is the transverse axis of the vehicle. The axis Y is oriented from the left to the right, the left and the right being defined according to the viewpoint of a driver of the vehicle. The axis Z is the axis perpendicular to the axis X and to the axis Y. The vehicle is considered to be on a horizontal ground. The axis Z is a vertical axis, oriented from bottom to top. The axes X, Y and Z form an orthogonal coordinate system. The same reference mark, defined by reference to a vehicle, will also be used to describe an arrangement of the vehicle, even when considered outside the vehicle, since same is intended to be mounted according to a specific orientation in the vehicle.

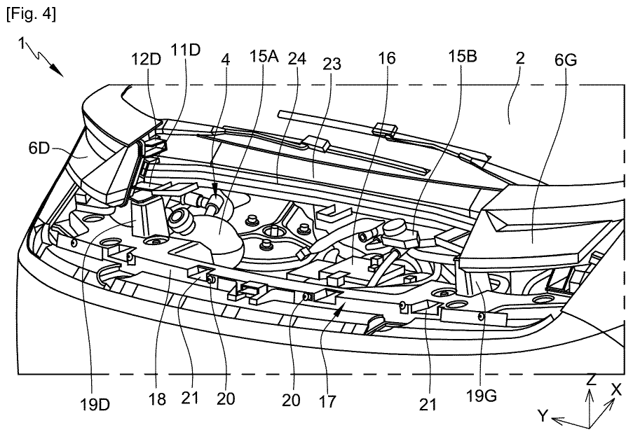

The vehicle 1 comprises a windscreen 2 and a front face 3 extending at the front of the vehicle, below the windscreen 2. The front face 3 also extends to the front of an engine compartment 4 (visible in FIG. 4) accommodating a power unit of the vehicle as well as different functional components. More particularly, the engine compartment can accommodate a battery, in particular a 12 Volt battery and/or fluid tanks, in particular tanks for windscreen washing liquid, and/or for cooling liquid, and/or for brake fluid and/or for lubricating oil.

According to the embodiment shown, the vehicle 1 comprises a particular arrangement of the front face 3 thereof. The present disclosure could nevertheless have variant for a rear face of a motor vehicle.

To make the engine compartment 4 accessible for maintenance operations, the front face 3 comprises a removable hood 5. “Removable” means that the hood 5 is movable so as to provide access to the engine compartment for the maintenance of the vehicle. The hood 5 is a kind of door that can be easily handled to access the engine compartment. The hood 5 comprises an external face visible from the outside of the vehicle and contributing to the aesthetic of the vehicle. The hood 5 may e.g. support a central lighting device and/or a logo of the brand or of the model of the vehicle.

The vehicle 1 further comprises a left lighting device 6G and a right lighting device 6D. The lighting devices 6G, 6D may e.g. be lighting devices intended to produce a position light. In a variant, the lighting devices could be configured to produce a different light function, e.g. a lighting function such as, e.g. low-beam headlights and/or high-beam headlights. The lighting devices 6G, 6D are positioned at the left wing and at a right wing, respectively, of the vehicle. The hood 5 extends between the two lighting devices 6G, 6D. The hood 5 comprises a left side extending opposite the left lighting device 6G, in particular opposite a right side of the left lighting device 6G. Similarly, the hood 5 comprises a right side facing the right lighting device 6G, in particular opposite a left side of the right lighting device 6G.

The hood 5 may have a height along the axis Z and/or a depth along the longitudinal axis X close to the height and/or depth of the lighting devices 6G, 6D.

The front face 3 further comprises an embellisher 7 positioned below the hood 5 and the lighting devices 6G and 6D. The front face 3 further comprises a shield 8 below the embellisher 7. As shown in FIG. 1, the shield 8 may integrate, if appropriate, secondary lighting devices 9G, 9D.

In order to gain access to the engine compartment 4, the hood 5 is arranged so as to be able to be completely removed from the vehicle. The hood 5 can thereby be completely detached from the vehicle. More particularly, the hood 5 is intended to be fitted and to be removed from the vehicle by a translational movement substantially parallel to the longitudinal axis X. “Substantially parallel to the longitudinal axis X” means that the translational movement of the hood can follow a direction forming an angle less than or equal to 45°, preferably less than or equal to 30°, with the longitudinal axis X. Else preferably, the fitting or the removal of the hood 5 takes place by a movement parallel to the longitudinal axis X and to the vertical axis Z. The hood 5 is said to be “in the closed position” or “in the closing position” when same is in place to close the engine compartment 4.

The left lighting device 6G and the right lighting device 6D comprise at least one left slide 11G, 12G, and at least one right slide 11D, 12D, respectively. In the present case, each lighting device 6G, 6D comprises two slides 11G and 12G and 11D and 12D, respectively However, according to variants of embodiments, each lighting device 6G, 6D could comprise only one slide or at least three slides, or even more slides.

The left side and the right side of the hood 5 comprise at least one left slider 13G, 14G and at least one right slider 13D, 14D, respectively. In the present case, each left or right side of the hood 5 comprises two sliders 13G and 14G, and 13D and 14D, respectively. In a variant, each side of the hood could comprise a different number of slides corresponding to the number of slides of the corresponding lighting device. Advantageously, the slides and sliders are arranged symmetrically on each side of the hood 5.

The two left sliders 13G, 14G cooperate with the two left slides 11G, 12G. Similarly, the two right sliders 13D, 14D cooperate with the two right slides 11D, 12D. The cooperation of the slides 11G, 12G, 11D, 12D with the sliders 13G, 14G, 13D, 14D serves firstly to guide the displacement of the hood according to a translational movement substantially parallel to the longitudinal axis X of the vehicle when the hood is fitted or when the hood is removed. On the other hand, the cooperation of the slides 11G, 12G, 11D, 12D with the sliders 13G, 14G, 13D, 14D is used to support at least part of the weight of the hood when same is in the closed position of the engine compartment 4.

The slides 11G, 12G can be formed in a wall of a housing of the lighting device 6G. Similarly, the slides 11D, 12D can be formed in a wall of a housing of the lighting device 6D. The slides 11G, 12G and 11D, 12D, respectively can form a single-piece assembly with the left lighting device 6G and the right lighting device 6D, respectively The slides 11G and 12G, and 11D and 12D, respectively, can be made of plastic and can be molded with at least one wall of a housing of the lighting devices 6G and 6D, respectively

The left slides 11G, 12G and the left sliders 13G, 14G will now be described more specifically, the design of the right slides and the right sliders being symmetrically identical.

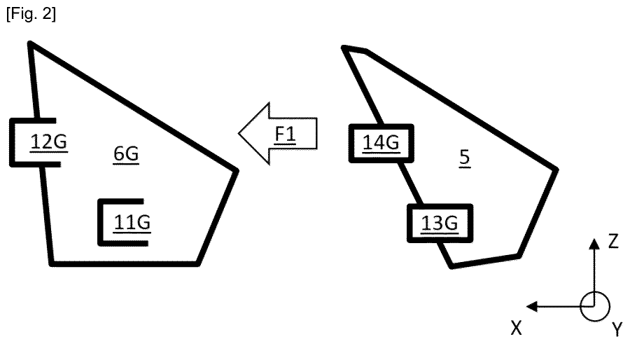

FIG. 2 schematically illustrates the hood 5 and the lighting device 6G when the hood is fitted. An arrow F1 represents the translational movement of the hood. It can be seen that the first slide 11G is offset along the longitudinal axis X and along the vertical axis Z with respect to the second slide 12G. More particularly, the first slide 11G is positioned further downwards and forwards relative to the second slide 12G. It is thereby possible to obtain a more stable holding of the hood 5 in the closed position and a better distribution of the forces exerted by the weight of the hood.

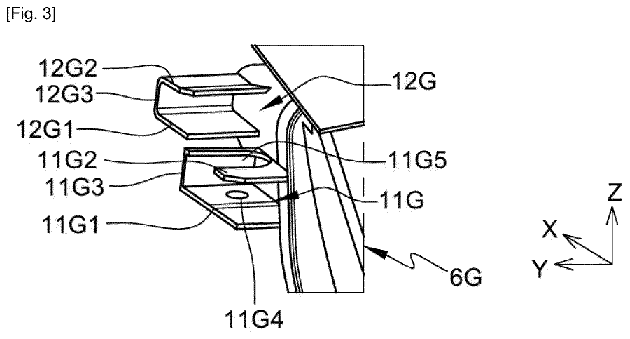

FIG. 3 illustrates in perspective the slides 11G and 12G. Each of the slides 11G and 12G comprises a substantially horizontal bottom wall 11G1, 12G1, a substantially horizontal top wall 11G2, 12G2, and a substantially vertical bottom wall 11G3, 12G3 connecting the bottom wall to the second top wall. Each slide thereby has substantially the shape of a stretched out “U”. The bottom walls 11G3 and 12G3 form stops cooperating with the sliders 13G and 14G to define the position of the hood along the longitudinal axis X. The bottom walls 11G1, 12G1 support at least part of the weight of the hood 5. The upper walls 11G2, 12G2 hold the hood in position along the vertical axis Z. Thereby, the hood is prevented from moving under the effect of vertical accelerations. Advantageously, all or part of the front ends of the walls 11G1, 11G2, 12G1 and 12G2 may be flared so as to facilitate the insertion of the slider into the corresponding slide.

It can be seen in FIG. 3 that the bottom wall 11G1 of the first left slide 11G comprises a circular opening 11G4. The circular opening is intended to cooperate with a fastening screw for fastening the lighting device 6G. Thereby, at least one rail of the left lighting device is also used to fasten the lighting device to a structural element of the vehicle. Advantageously, the upper wall 11G2 of the first left slide 11G also comprises an opening 11G5. The opening 11G5 lets through a tool such as a screwdriver for having access to the fastening screw cooperating with the opening 11G4.

FIG. 4 illustrates the vehicle 1 after the removal of the hood 5 and the embellisher 7. It can be seen that the engine compartment 4 contains in particular different tanks 15A, 15B, and a 12V battery 16. It will also be observed that the vehicle 1 further comprises a structural element 17, in particular a cross-member, extending over the width of the vehicle 1. The structural element 17 is an element of the body of the vehicle 1. Same is a rigid element, intended to support the weight of at least some of the components arranged in the engine compartment. The structural element 17 may comprise a plastic body and a metal reinforcement embedded in the plastic body.

The structural element 17 comprises in particular a main beam 18 extending parallel to the transverse axis Y and supports 19G, 19D, or small columns, extending upwards from the main beam 18. More particularly, the structural element 17 comprises a left support 19G and a right support 19D. The lower wall 11G1 of the first slide 11G of the left lighting device 6G rests on an upper face of the left support 19G. Similarly, the lower wall of the first slide 11D of the right lighting device 6D rests on an upper face of the right support 19D. It should thus be understood that the structural element 17 supports at least part of the weight of each lighting device 6G, 6D. The fastening screw cooperating with the opening 11G4 described hereinabove is screwed into the left support 19G. The left lighting device (and likewise the right lighting device) is thereby fastened to the structural element 17.

The main beam 18 further comprises supplementary fastening interfaces for the hood 5. More precisely, the main beam 18 comprises a set of fastening holes cooperating with fastening screws 20. The fastening screws 20 are configured to fasten a lower edge of the hood 5 to the structural element 17. It should thus be understood that the hood 5 is held onto the vehicle 1 both by means of the slides 11G, 12G, 11D, 12D provided on the lighting devices and by means of the fastening screws 20. The fastening screws 20 thus provide an additional means of fastening for the hood which serves to secure same in the closed position. Advantageously, the fastening screws 20 are then masked by the embellisher 7.

In addition, the main beam 18 comprises a front opening assembly 21 positioned close to the fastening screws 20. The front openings 21 are intended to cooperate with longitudinal tabs 22 provided at a lower edge of the hood 5. The cooperation of the longitudinal tabs 22 with the front openings 21 serves to position the hood 5 correctly relative to the structural element 17.

To remove the hood 5, it is thus necessary to remove the embellisher, to unscrew the fastening screws 20, then to pull on the hood along the longitudinal axis X. To reposition the hood 5, it is necessary to insert the sliders 13G, 14G, 13D, 14D of the hood into the slides 11G, 12G, 11D, 12D and the longitudinal tongues 22 in the front openings 21. The hood is then pushed along the longitudinal axis X until the sliders reach the bottom walls of the respective slides. The fastening crews 20 are then screwed in and the embellisher 7—which masks the fastening screws 20—is then repositioned. Such operations are easy to carry out. According to one embodiment, the fastening screws 20 could be replaced by quick-coupling devices or by any other equivalent means of fastening.

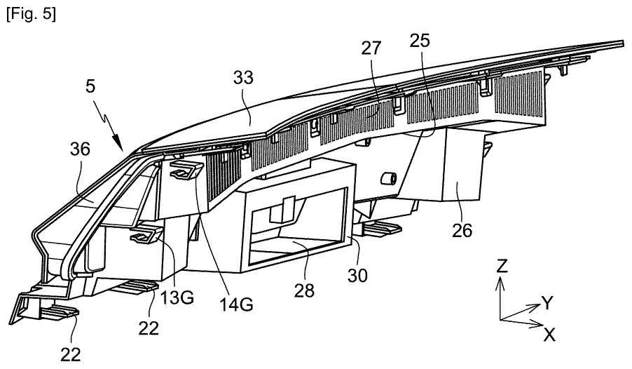

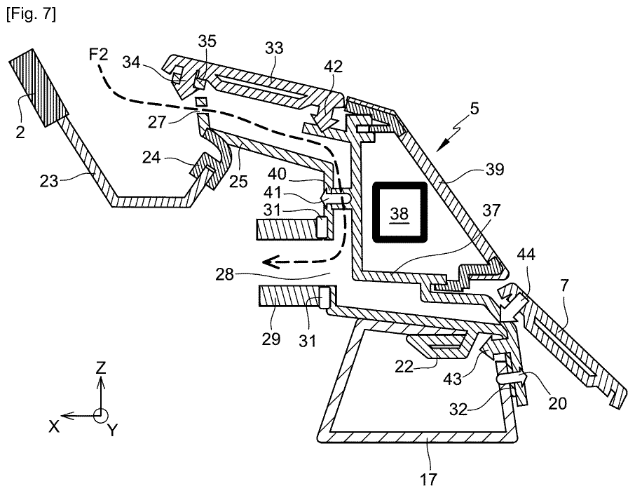

In FIG. 4, it can also be seen that the vehicle 1 comprises a cowl grille 23 extending below the windscreen 2 in order to receive and remove rainwater which has fallen against the windscreen. The cowl grille 23 comprises an edge equipped with a seal 24. The seal 24 extends transversely below the windscreen 2 between the two lighting devices 6G, 6D. Advantageously, the hood 5 further comprises a sealing surface 25 (illustrated in FIGS. 5 and 7) bearing against the seal 24. Thereby, the hood 5 also performs a sealing function preventing rainwater from entering massively into the engine compartment 4.

FIG. 5 illustrates the hood 5 taken alone. The slides 13G, 14G, 13D, 14D can also be made in the form of a stretched-out “U”. Each comprises a bottom wall, a top wall, and a bottom wall connecting the bottom wall to the top wall. The distance between the bottom wall and the top wall of each slider is chosen so that the sliders can be housed within the respective slides. When the hood is in the closed position, an upper face of the upper wall of each slider can bear against a lower face of the upper wall of the corresponding slide.

Similarly, a lower face of the lower wall of each slider may bear against an upper face of the lower wall of the corresponding slide. Similarly, the bottom wall of the slider may bear against the bottom wall of the corresponding slide. The sliders 13G, 14G, 13D, 14D can be made of plastic and can be molded with a plastic body 26 of the hood.

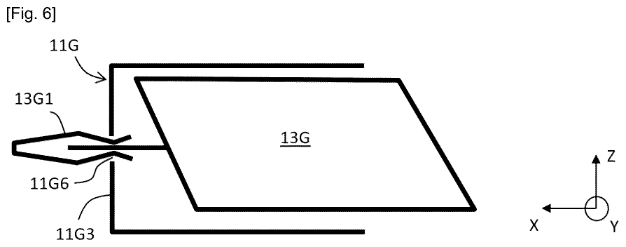

FIG. 6 illustrates a variant of embodiment of at least one slide and of the corresponding slider. The variant of embodiment may equip all or part of the slides 11G, 12G, 11D, 12D and of the corresponding sliders 13G, 14G, 13D, 14D. FIG. 6 shows such variant of embodiment arbitrarily in relation to the first left slide 11G and the first left slider 13G. According to such variant of embodiment, the slider 13G comprises an elastic element 13G1 which can be snap-fitted into the slide 11G. The elastic element 13G1 is an element intended to be elastically deformed when the hood 5 is fitted, in order to stabilize the closed position of the hood. According to one embodiment, the bottom wall 11G3 comprises an opening 11G6 and the elastic element 13G1 is positioned at the rear of the slider 13G. The elastic element 13G1 is intended to be inserted into the opening 11G6. The elastic element 13G1 is intended in particular to deform elastically when same extends through the opening 11G6 and then to relax when same has completely crossed through the opening 11G6. The elastic element 11G6 advantageously comprises ramps intended to bear on edges of the opening 11G6 to deform the elastic element. Thereby, a user manipulating the hood simply feels an increased resistance when the elastic element is tensioned during the insertion or during the extraction of the hood. In addition to securing the closed position of the hood, the elastic element provides a haptic indication of the correct fitting of the hood 5.

With reference to FIG. 7, the hood 5 further comprises an air inlet 27 for capturing air outside the vehicle and an air outlet 28 connected to a conduit 29 of a ventilation device of the vehicle 1. The air inlet 27 is oriented toward the rear of the vehicle. Same is positioned above the cowl grille 23. The air inlet 27 may comprise a filter to prevent the passage of large particles. The air inlet 27 may extend over the entire width of the hood, between the sliders 14G and 14D. The air outlet 28 can be positioned below the air inlet 27. The air outlet 28 may comprise a contour 30 intended to bear on a seal 31 at the interface between the conduit 29 and the hood 5. The conduit 29 may extend parallel to the longitudinal axis X toward the rear of the vehicle.

When the vehicle is in operation, an air flow, illustrated by an arrow F2 in FIG. 7, can thus circulate inside the cowl 5 between the air inlet 27 and the air outlet 28. The air flow is channeled by different internal walls of the hood 5.

With reference to FIG. 7, it can be seen that the hood 5 can be made by assembling a plurality of parts or components. All the parts forming the structure of the hood may be made of plastic. Same may in particular be obtained by molding.

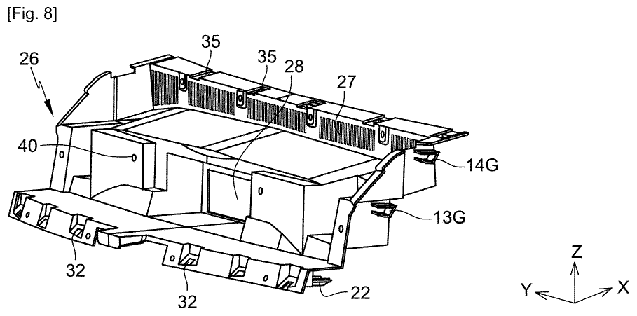

A first component of the hood 5 corresponds to the body 26 mentioned hereinabove. The body is shown in particular in FIG. 8. The body 26 comprises in particular the sliders 13G, 14G, 13D, 14D, the longitudinal tabs 22, the sealing surface 25, the air inlet 27 and the air outlet 28. The body 26 further comprises first fastening interfaces 32, e.g. holes, cooperating with the fastening screws 20.

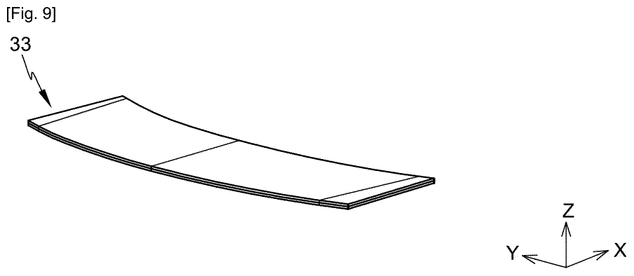

A second component of the hood 5 is a cover 33. The cover 33 is, in particular, illustrated alone in FIG. 9. The cover 33 comprises an outer face visible from the outside of the vehicle. The cover 33 can have an aesthetic function for the front face 3. The outer face of the cover 33 may be painted in the color of the vehicle body. The cover 33 is fastened to the body 26 by means of fastening clips 34. The fastening clips 34 cooperate with second fastening interfaces 35, in particular holes, provided in an upper edge of the body 26.

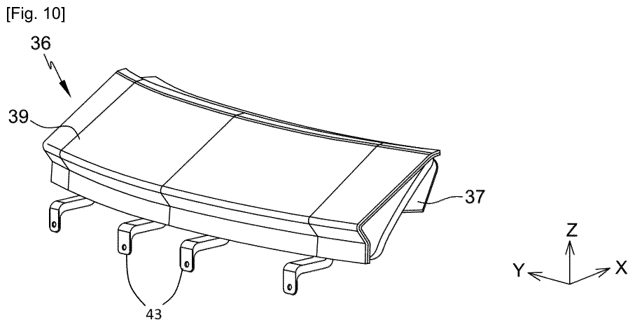

A third component of the hood 5 is a central lighting device 36. The central lighting device 36 is, in particular, illustrated alone in FIG. 10. The central lighting device 36 comprises a housing 37 inside which a light source 38 is arranged. The casing 37 is closed by a transparent or translucent mirror 39 through which are emitted the light rays coming from the light source 38. The mirror 39 can be glued to the housing 37. The mirror 39 can extend transversely from the left lighting device 6G to the right lighting device 6D. The continuity of light can thereby be formed between the lighting devices 6G and 6D. The mirror 39 can be inclined upwards and backwards. Means of electrical connection are configured to supply the central lighting device, in particular the light source 38, with electrical energy. The means of electrical connection can pass through an opening provided in a rear wall of the housing 37.

The body 26 may comprise third fastening interfaces 40, in particular holes cooperating with fastening screws 41 and with the housing 37 to fasten the central lighting device 36 to the body 26. Furthermore, the cover 33 can also be fasten to the housing 37 by means of fastening clips 42. Furthermore, the housing 37 can also be fasten to the structural element 17 by fastening lugs 43 or fastening clips. A lower wall of the body 26 may be sandwiched between the housing 37 and the structural element 17. The embellisher 7 can be fastened to the housing 37 by fastening clips 44 so as to cover the fastening screws 20.

According to a variant of embodiment, the hood 5 could be formed by assembling a different number of components. More particularly, the casing 37 and the body 26 could form one and the same component, in particular one and the same component obtained by molding. Alternatively, the cover 33 and the body 26 could form one and the same component, in particular one and the same component obtained by molding. Alternatively, the cover 33 and the casing 37 could form one and the same component, in particular one and the same component obtained by molding. Alternatively, the body 26, the cover 33 and the casing 37 could form one and the same component, in particular one and the same component obtained by molding.

What is claimed is:

1. An arrangement for a motor vehicle, comprising:
an engine compartment;
a left lighting device;
a right lighting device; and
a hood covering the engine compartment,
wherein the hood is configured to be removable so as to provide access to the engine compartment, the hood is configured to extend between the left lighting device and the right lighting device, the hood comprises a left side extending opposite the left lighting device and a right side extending opposite the right lighting device, the left lighting device and the right lighting device comprise at least one left slide and at least one right slide, respectively, the left side and the right side of the hood comprise at least one left slider and at least one right slider, respectively, the at least one left slider cooperates with the at least one left slide and the at least one right slider cooperates with the at least one right slide to guide a movement of the hood parallel to a longitudinal axis of the motor vehicle and to support the hood.

2. The arrangement according to claim 1, wherein the at least one left slide comprises a substantially horizontal bottom wall, a substantially horizontal top wall, and a substantially vertical bottom wall connecting the substantially horizontal bottom wall of the at least one left slide to the substantially horizontal top wall of the at least one left slide, the substantially vertical bottom wall of the at least one left slide forms a stop cooperating with at least one left slider so as to define a position of the hood along the longitudinal axis when the hood is a closed position, and/or
wherein the at least one right slide comprises a substantially horizontal bottom wall, a substantially horizontal top wall, and a substantially vertical bottom wall connecting the substantially horizontal bottom wall of the at least one right slide to the substantially horizontal top wall of the at least one right slide, the substantially vertical bottom wall of the at least one right slide forms a stop cooperating with at least one right slider so as to define the position of the hood along the longitudinal axis when the hood is in the closed position.

3. The arrangement according to claim 1, wherein the at least one left slider comprises an elastic element configured to be snap-fitted into the at least one left slide, and/or wherein the at least one right slider comprises an elastic element configured to be snap-fitted into the at least one right slide.

4. The arrangement according to claim 1, wherein:
the at least one left slide comprises a first left slide and a second left slide,
the at least one right slide comprises a first right slide and a second right slide,
the at least one left slider comprises a first left slider cooperating with the first left slide and a second left slider cooperating with the second left slide,
the first right slide comprises a first right slider cooperating with the first right slide and a second right slider cooperating with the second right slide,
wherein the first left slide is offset along the longitudinal axis and along a vertical axis relative to the second left slide, the first right slide is offset along the longitudinal axis and along a vertical axis relative to the second right slide.

5. The arrangement according to claim 1, wherein the arrangement further comprises a windscreen, a cowl grille extending below the windscreen for receiving rainwater which has fallen against the windscreen, wherein the cowl grille comprises an edge equipped with a seal, said hood further comprises a sealing surface bearing against the seal.

6. The arrangement according to claim 1, wherein the hood further comprises at least one air inlet for capturing air outside the motor vehicle and an air outlet intended to be connected to a conduit of a ventilation device.

7. The arrangement according to claim 1, wherein the arrangement comprises a structural element, the hood further comprising fastening interfaces by means of which the hood is fastened to the structural element.

8. The arrangement according to claim 7, wherein the structural element is a cross member.

9. The arrangement according to claim 7, wherein the hood is screwed to the structural element.

10. The arrangement according to claim 1, wherein the arrangement comprises a structural element, the structural element comprises a left support and a right support, the at least one left slide bears on the left support, the at least one right slide bears on the right support.

11. The arrangement according to claim 10, wherein the structural element is a cross member.

12. The arrangement according to claim 1, wherein the hood further comprises a central lighting device provided with a light source.

13. A motor vehicle, wherein the motor vehicle comprises the arrangement according to claim 1.

14. The motor vehicle according to claim 13, comprising a front face provided with the arrangement.
